(19) United States
(12) Patent Application Publication
(10) Pub. No.: US 2024/0029292 A1
(43) Pub. Date: Jan. 25, 2024

(54) POSITION SPECIFICATION DEVICE, POSITION SPECIFICATION METHOD, PROGRAM, AND POSITION SPECIFICATION SYSTEM

(71) Applicant: FUJIFILM Corporation, Tokyo (JP)

(72) Inventor: Kyota WATANABE, c/o FUJIFILM Corporation (JP)

(73) Assignee: FUJIFILM Corporation, Tokyo (JP)

(21) Appl. No.: 18/180,606

(22) Filed: Mar. 8, 2023

Related U.S. Application Data
(63) Continuation of application No. PCT/JP21/33250, filed on Sep. 10, 2021.

(30) Foreign Application Priority Data
Sep. 18, 2020 (JP) 2020-157128

(51) Int. Cl. G06T 7/70; G06V 20/17; G06K 7/14

(52) U.S. Cl. CPC G06T 7/70; G06V 20/17; G06K 7/1417; G06K 7/1443; G06T 2207/10024

(57) ABSTRACT

Provided are a position specification device, a position specification method, a program, and a position specification system which specify a position in an image without setting a landmark in advance. An image of a ground surface including a position reference moving object including a visual identifier is acquired, the image being captured by a camera provided in an imaging flying object that flies over the sky, the identifier is detected from the image, position information of the position reference moving object during capturing of the image is acquired, and a position of the ground surface in the image is specified from the detected identifier and the position information.

### CROSS-REFERENCE TO RELATED APPLICATIONS

The present application is a Continuation of PCT International Application No. PCT/JP2021/033250 filed on Sep. 10, 2021 claiming priority under 35 U.S.0 § 119(a) to Japanese Patent Application No. 2020-157128 filed on Sep. 18, 2020. Each of the above applications is hereby expressly incorporated by reference, in its entirety, into the present application.

### BACKGROUND OF THE INVENTION

### 1. Field of the Invention

The present invention relates to a position specification device, a position specification method, a program, and a position specification system, and particularly relates to a technique of specifying a position in an image.

### 2. Description of the Related Art

In order to specify what a feature shown in an image captured from a high place is and where the feature is, it is necessary to make the image correspond to map data. In this case, there is a method of performing registration between the image and the map data with the information on the latitude and the longitude given from the outside at some points in the image as a starting point.

JP2014-220604A discloses a technique of setting a landmark for which position information is registered in advance, reflecting the landmark in a captured image, and specifying a position of a feature in the image by using the position information of the landmark in the image as a starting point.

### SUMMARY OF THE INVENTION

In a case of a disaster, it is possible to quickly grasp a damage situation by using an image of a city area imaged from a high place. Here, in order to perform a detailed damage analysis, it is necessary to collate with the map data and specify a position relationship and types of the features in the image. However, the method of setting the landmark in advance as in JP2014-220604A has a problem that the landmark may not function as a position reference due to damage of the landmark caused by the disaster or the like.

The present invention has been made in view of such circumstances, and is to provide a position specification device, a position specification method, a program, and a position specification system which specify a position in an image without setting a landmark in advance.

In order to achieve the object described above, an aspect of the present invention relates to a position specification device comprising a memory that stores a command to be executed by a processor, and the processor that executes the command stored in the memory, in which the processor acquires an image of a ground surface including a position reference moving object including a visual identifier, the image being captured by a camera provided in an imaging flying object that flies over the sky, detects the identifier from the image, acquires position information of the position reference moving object during capturing of the image, and specifies a position of the ground surface in the image from the detected identifier and the position information.

According to the present aspect, the identifier is detected from the image of the ground surface including the position reference moving object, the position information of the position reference moving object during capturing of the image is acquired, and the position of the ground surface in the image is specified from the detected identifier and the position information, so that the position in the image can be specified without setting the landmark in advance.

It is preferable that the identifier include a color defined for each position reference moving object. As a result, the position information of the position reference moving object can be appropriately acquired.

It is preferable that the identifier include a figure defined for each position reference moving object. As a result, the position information of the position reference moving object can be appropriately acquired.

It is preferable that the identifier include a two-dimensional barcode in which the position information is encoded. The position information of the position reference moving object can be appropriately acquired.

It is preferable that the position reference moving object be a flying object that flies at an altitude lower than an altitude of the imaging flying object, and the position information include altitude information. As a result, the position reference moving object can be moved to an appropriate position regardless of a condition of the ground surface, and the position of the flying object during capturing of the image can be appropriately acquired.

It is preferable that the processor acquire elevation angle information of the camera during capturing of the image, and specify a position of the ground surface immediately below the position reference moving object in the image based on the altitude information and the elevation angle information. As a result, even in a case in which the camera has the elevation angle during capturing of the image, the position of the ground surface immediately below the position reference moving object in the image can be specified.

It is preferable that the processor move the position reference moving object to a position within an angle of view of the camera in a case in which the position reference moving object is not present within the angle of view of the camera. As a result, the image of the ground surface including the position reference moving object can always be captured.

It is preferable that the processor move the position reference moving object, which has a smallest number of times the position information is acquired among a plurality of the position reference moving objects, to the position within the angle of view of the camera. As a result, a frequency of use of each of the plurality of position reference moving objects can be equalized.

In order to achieve the object described above, another aspect of the present invention relates to a position specification system comprising the position specification device described above, the position reference moving object, and the imaging flying object including the camera.

According to the present aspect, the identifier is detected from the image of the ground surface including the position reference moving object, the position information of the position reference moving object during capturing of the image is acquired, and the position of the ground surface in the image is specified from the detected identifier and the position information, so that the position in the image can be specified without setting the landmark in advance. The position specification device may be provided in the position reference moving object or may be provided in the imaging flying object. A part of the function of the position specification device may be distributed to the position reference moving object and the imaging flying object.

In order to achieve the object described above, still another aspect of the present invention relates to a position specification method comprising an image acquisition step of acquiring an image of a ground surface including a position reference moving object including a visual identifier, the image being captured by a camera provided in an imaging flying object that flies over the sky, a detection step of detecting the identifier from the image, a position information acquisition step of acquiring position information of the position reference moving object during capturing of the image, and a specification step of specifying a position of the ground surface in the image from the detected identifier and the position information.

According to the present aspect, the identifier is detected from the image of the ground surface including the position reference moving object, the position information of the position reference moving object during capturing of the image is acquired, and the position of the ground surface in the image is specified from the detected identifier and the position information, so that the position in the image can be specified without setting the landmark in advance.

In order to achieve the object described above, still another aspect of the present invention relates to a program causing a computer to execute the position specification method described above. A computer-readable non-transitory recording medium on which the program is recorded may also be included in the present aspect.

According to the present aspect, the identifier is detected from the image of the ground surface including the position reference moving object, the position information of the position reference moving object during capturing of the image is acquired, and the position of the ground surface in the image is specified from the detected identifier and the position information, so that the position in the image can be specified without setting the landmark in advance.

According to the present invention, the position in the image can be specified without setting the landmark in advance.

### BRIEF DESCRIPTION OF THE DRAWINGS

FIG. 1 is a schematic diagram of a position specification system.

FIG. 2 is a block diagram showing a configuration of an imaging drone.
FIG. 3 is a block diagram showing a configuration of a position reference drone.
FIGS. 4A and 4B are diagrams showing examples of disposition of a LED light.
FIG. 5 is a block diagram showing a configuration of a position information storage server.

FIG. 6 is a functional block diagram of the position specification system.
FIG. 7 is a flowchart showing each step of a position specification method.
FIG. 8 is a diagram showing an example of positions of the imaging drone and the position reference drone.

FIG. 9 is a diagram for describing a position of a ground surface immediately below the position reference drone.

FIG. 10 is an example of an image captured by an imaging unit.

### DESCRIPTION OF THE PREFERRED EMBODIMENTS

Hereinafter, preferred embodiments of the present invention will be described in detail with reference to the accompanying drawings.

### Overall Configuration of Position Specification System

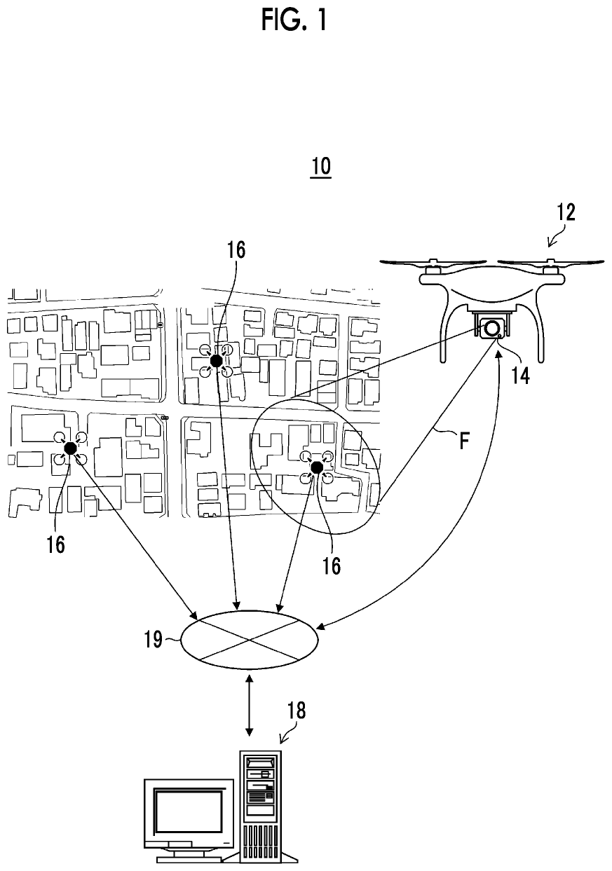

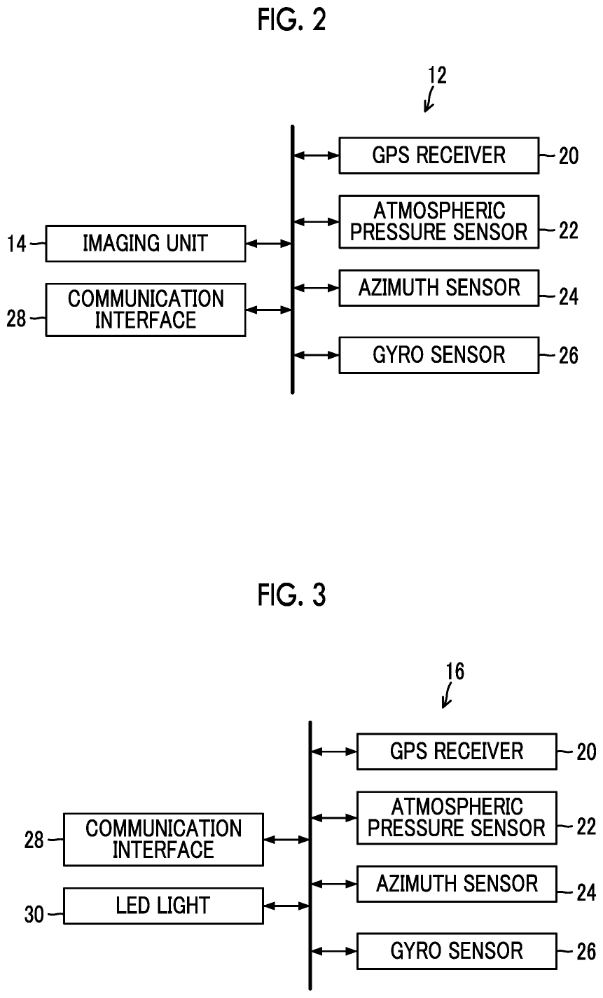

FIG. 1 is a schematic diagram of a position specification system 10 according to the present embodiment. As shown in FIG. 1, the position specification system 10 includes an imaging drone 12, a position reference drone 16, and a position information storage server 18.

The imaging drone 12 is an unmanned aerial vehicle (UAV, an example of a flying object) that is remotely operated by the position information storage server 18 or a controller (not shown). The imaging drone 12 may have an auto-pilot function of flying according to a predetermined program.

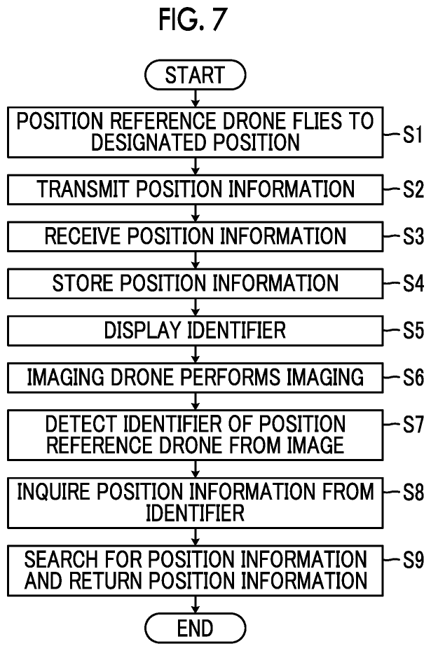

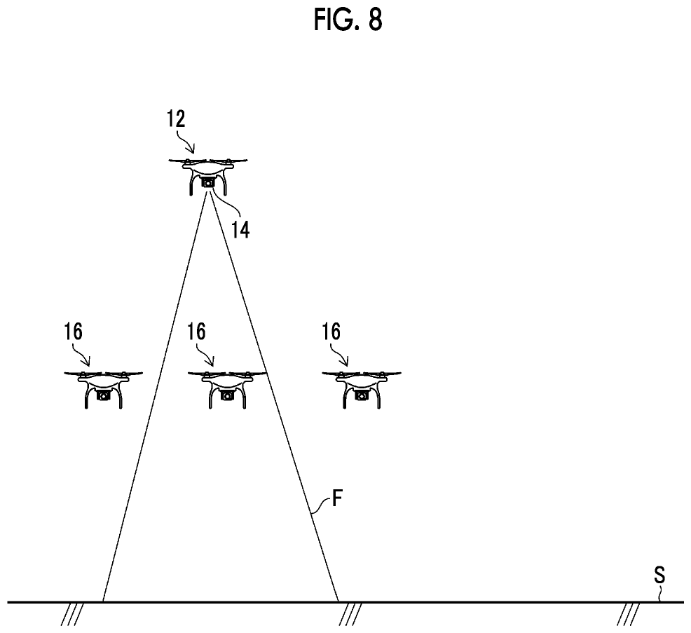

The imaging drone 12 comprises an imaging unit 14. The imaging unit 14 is a camera comprising a lens (not shown) and an imaging element (not shown). The imaging unit 14 is supported by the imaging drone 12 through a gimbal (not shown). The lens of the imaging unit 14 images subject light received from an imaging range (angle of view) F on an imaging plane of an imaging element. The imaging element of the imaging unit 14 receives the subject light imaged on the imaging plane and outputs an image signal of a subject. The imaging drone 12 captures an image of a ground surface S (see FIG. 8) including the position reference drone 16 by the imaging unit 14. The ground surface S is a surface of the earth, is not limited to the ground, and includes a sea surface and a lake surface.

The position reference drone 16 is an unmanned aerial vehicle that is remotely operated by the position information storage server 18 or a controller (not shown), similarly to the imaging drone. The position reference drone 16 may have an auto-pilot function of flying according to a predetermined program. The position reference drone 16 flies at the altitude lower than the altitude of the imaging drone 12. FIG. 1 shows three position reference drones 16, but the number of position reference drones 16 is not limited.

The position information storage server 18 is implemented by at least one computer and constitutes at least a part of the position specification device. The imaging drone 12, the position reference drone 16, and the position information storage server 18 are connected to each other to be able to transmit and receive data via a communication network 19, such as a 2.4 GHz band wireless local area network (LAN).

### Configuration of Drone

FIG. 2 is a block diagram showing a configuration of the imaging drone 12. As shown in FIG. 2, the imaging drone 12 comprises a global positioning system (GPS) receiver 20, an atmospheric pressure sensor 22, an azimuth sensor 24, a gyro sensor 26, and a communication interface 28, in addition to the imaging unit 14 described above.

The GPS receiver 20 acquires information on the latitude and the longitude of the imaging drone 12. The atmospheric pressure sensor 22 acquires information on the altitude of the imaging drone 12 from the detected atmospheric pressure. Here, the information on the latitude and the longitude and the information on the altitude may be referred to as position information. The azimuth sensor 24 acquires an orientation of the imaging drone 12 from the detected azimuth. The gyro sensor 26 acquires posture information of the imaging drone 12 from the detected angles of a roll axis, a pitch axis, and a yaw axis. The communication interface 28 controls communication via the communication network 19.

The imaging drone 12 may acquire information on a remaining amount of a battery (not shown). Moreover, the imaging unit 14 may acquire the angles of the roll axis, the pitch axis, and the yaw axis of an optical axis of a lens by the gyro sensor (not shown) provided in the imaging unit 14.

FIG. 3 is a block diagram showing a configuration of the position reference drone 16. As shown in FIG. 3, the position reference drone 16 comprises the GPS receiver 20, the atmospheric pressure sensor 22, the azimuth sensor 24, the gyro sensor 26, the communication interface 28, and a light emitting diode (LED) light 30.

The configurations of the GPS receiver 20, the atmospheric pressure sensor 22, the azimuth sensor 24, the gyro sensor 26, and the communication interface 28 are the same as those of the imaging drone 12.

The position reference drone 16 comprises the LED light 30 as a visual identifier display unit for uniquely identifying the position reference drone 16. The LED light 30 is provided on a top surface of the position reference drone 16 to be visible in a case in which the position reference drone 16 is viewed from a bird's-eye view. A specific color is assigned to each position reference drone 16, and the LED light 30 is set to be turned on by the assigned color (an example of a color defined for each position reference moving object). Moreover, in order to distinguish between the identifier of the position reference drone 16 and the light in the city, the LED light 30 is mounted to form a specific figure pattern (an example of a figure defined for each position reference moving object).

FIGS. 4A and 4B are diagrams showing examples of disposition of the LED light 30. FIGS. 4A and 4B show the disposition of the LED light 30 in a case in which the position reference drone 16 is viewed from above. FIG. 4A shows the LED light 30 including five LED lights 30A, 30B, 30C, 30D, and 30E. The LED light 30 shown in FIG. 4A forms a cross-shaped figure pattern by disposing the four LED lights 30A, 30B, 30C, and 30D at positions forming the apex of the rectangle and disposing the LED light 30E at the center of the rectangle. Moreover, the colors of the five LED lights 30A, 30B, 30C, 30D, and 30E are, for example, red. Therefore, the position reference drone 16 comprising the LED light 30 shown in FIG. 4A has a red cross-shaped figure pattern as the visual identifier.

FIG. 4B shows the LED light 30 including six LED lights 30F, 30G, 30H, 301, 30J, and 30K. The LED light 30 shown in FIG. 4B forms a hexagonal (circular) figure pattern by disposing the six LED lights 30F, 30G, 30H, 301, 30J, and 30K at positions forming the apex of the hexagon, respectively. Moreover, the colors of the six LED lights 30F, 30G, 30H, 301, 30J, and 30K are, for example, yellow. Therefore, the position reference drone 16 comprising the LED light 30 shown in FIG. 4B has a yellow hexagonal (circular) figure pattern as the visual identifier.

### Configuration of Position Information Storage Server

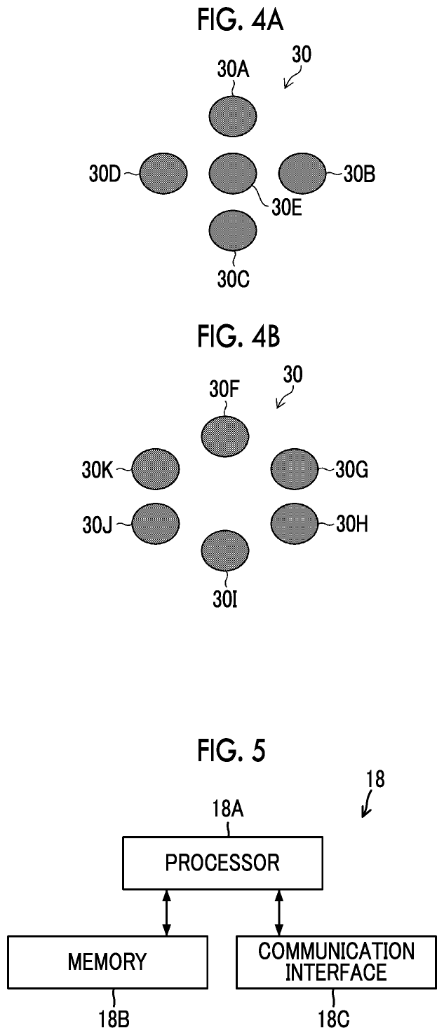

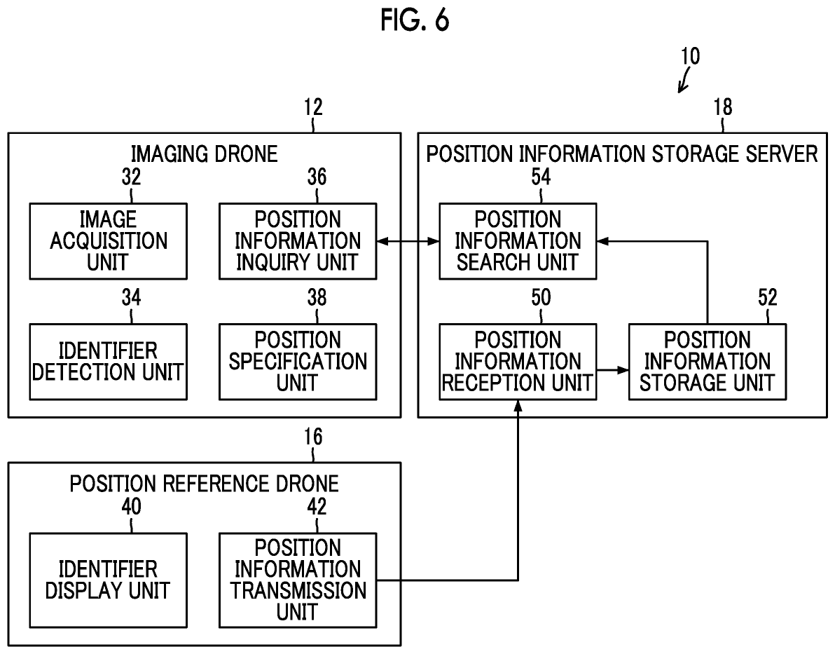

FIG. 5 is a block diagram showing a configuration of the position information storage server 18. The position information storage server 18 comprises a processor 18A, a memory 18B, and a communication interface 18C.

The processor 18A executes a command stored in the memory 18B. A hardware structure of the processor 18A is various processors as shown below. Various processors include a central processing unit (CPU) as a general-purpose processor which functions as various function units by executing software (program), a graphics processing unit (GPU) as a processor specialized in image processing, a programmable logic device (PLD) as a processor of which a circuit configuration can be changed after manufacture, such as a field programmable gate array (FPGA), and a dedicated electric circuit as a processor which has a circuit configuration specifically designed to execute specific processing, such as an application specific integrated circuit (ASIC).

One processing unit may be configured by one of these various processors, or two or more processors of the same type or different types (for example, a plurality of FPGAs, or a combination of a CPU and an FPGA, or a combination of a CPU and a GPU). Moreover, a plurality of function units may be configured by one processor. As a first example in which the plurality of function units are configured by one processor, as represented by a computer such as a client or a server, there is a form in which one processor is configured by a combination of one or more CPUs and software, and this processor operates as the plurality of function units. As a second example thereof, as represented by a system on chip (SoC), there is a form in which a processor that implements the functions of the entire system including the plurality of function units by one integrated circuit (IC) chip is used. As described above, various function units are configured by one or more of the various processors described above as the hardware structure.

Further, the hardware structures of these various processors are, more specifically, an electric circuit (circuitry) in which circuit elements such as semiconductor elements are combined.

The memory 18B stores the command executed by the processor 18A. The memory 18B includes a random access memory (RAM) and a read only memory (ROM) (not shown). The processor 18A uses the RAM as a work region, executes software by using various programs and parameters including a position specification program stored in the ROM, and uses the parameters stored in the ROM or the like to execute various pieces of processing of the position information storage server 18.

The communication interface 18C controls communication via the communication network 19.

It should be noted that the imaging drone 12 and the position reference drone 16 may also have the same configurations as the position information storage server 18 shown in FIG. 5.

### Functional Configuration of Position Specification System

FIG. 6 is a functional block diagram of the position specification system 10. As shown in FIG. 6, the position specification system 10 comprises an image acquisition unit 32, an identifier detection unit 34, a position information inquiry unit 36, a position specification unit 38, an identifier display unit 40, a position information transmission unit 42, a position information reception unit 50, a position information storage unit 52, and a position information search unit 54. The functions of the image acquisition unit 32, the identifier detection unit 34, the position information inquiry unit 36, and the position specification unit 38 are implemented by the imaging drone 12. The functions of the identifier display unit 40 and the position information transmission unit 42 are implemented by the position reference drone 16. The functions of the position information reception unit 50, the position information storage unit 52, and the position information search unit 54 are implemented by the position information storage server 18.

The image acquisition unit 32 acquires an image of the ground surface including the position reference drone 16 including a visual identifier, the image being captured by the imaging unit 14. The identifier detection unit 34 detects the visual identifier of the position reference drone 16 from the image acquired by the image acquisition unit 32. The position information inquiry unit 36 transmits the identifier detected by the identifier detection unit 34 to the position information storage server 18 and inquires the position information of the position reference drone 16 included in the image.

The identifier display unit 40 turns on the LED light 30 to cause the position reference drone 16 to display the visual identifier. The position information transmission unit 42 transmits the information on the latitude and the longitude of the position reference drone 16 acquired by the GPS receiver 20 and the information on the altitude (an example of altitude information) of the position reference drone 16 acquired by the atmospheric pressure sensor 22, to the position information storage server 18, as the position information.

The position information reception unit 50 receives the position information of the position reference drone 16 transmitted from the position information transmission unit 42 and stores the position information in the position information storage unit 52. The position information storage unit 52 is configured by the memory 18B and stores the position information of a plurality of position reference drones 16.

The position information search unit 54 searches for the corresponding position reference drone 16 from the position information storage unit 52 based on the identifier transmitted from the position information inquiry unit 36, and returns the position information that is a search result to the position information inquiry unit 36.

### Position Specification Method: First Embodiment

FIG. 7 is a flowchart showing each step of a position specification method. The position specification method is implemented by executing the position specification program stored in the respective memories 18B by the respective processors 18A of the imaging drone 12, the position reference drone 16, and the position information storage server 18. The position specification program may be provided by a computer-readable non-transitory recording medium. In this case, each of the imaging drone 12, the position reference drone 16, and the position information storage server 18 may read the position specification program from the non-transitory recording medium and store the position specification program in the memory 18B.

In step S1, the position information storage server 18 causes the plurality of position reference drones 16 to fly over the sky at a designated position.

In step S2, in a case in which each of the plurality of position reference drones 16 arrives at the designated position, the position reference drone 16 hovers at that position and acquires the information on the latitude and the longitude of the position reference drone 16 by using the GPS receiver 20. Moreover, the position reference drone 16 acquires the information on the altitude of the position reference drone 16 by using the atmospheric pressure sensor 22. The position information transmission unit 42 of each position reference drone 16 transmits the position information including the information on the latitude and the longitude and the information on the altitude of the position reference drone 16 to the position information storage server 18. It is preferable that the position information transmission unit 42 transmit the position information and time point information in association with each other. Moreover, the position information transmission unit 42 transmits identifier information of the position reference drone 16 to the position information storage server 18. Here, the identifier information is information in which the color and the figure pattern of the LED light 30 are encoded into numerical values.

In step S3, the position information reception unit 50 of the position information storage server 18 receives the position information and the identifier information transmitted from the plurality of position reference drones 16.

In step S4, the position information reception unit 50 stores the position information received in step S3 in the position information storage unit 52 in association with the identifier information.

In step S5, the identifier display unit 40 of each position reference drone 16 turns on the LED light 30 in a state in which the position reference drone 16 hovers.

In step S6 (an example of an image acquisition step), the imaging drone 12 captures the city area by the imaging unit 14 while flying over the sky at the altitude higher than the altitude of the position reference drone 16. Moreover, the image acquisition unit 32 acquires the image captured by the imaging unit 14. It is preferable that the image acquisition unit 32 acquire the time point information in which the image is captured and associates the image with the time point information.

FIG. 8 is a diagram showing an example of the positions of the imaging drone 12 and the position reference drone 16 in step S6. As shown in FIG. 8, the imaging unit 14 of the imaging drone 12 captures the image of the ground surface S including the position reference drone 16 flying at the altitude lower than the altitude of the imaging drone 12 in the imaging range F. In the example shown in FIG. 8, although one position reference drone 16 among the three position reference drones 16 is included in the imaging range F, the plurality of position reference drones 16 may be included in the imaging range F.

Returning to the description of FIG. 7, in step S7 (an example of a detection step), the identifier detection unit 34 detects the color and the figure pattern of the LED light 30 that is the identifier of the position reference drone 16 included in the image acquired by the image acquisition unit 32, by an analysis program. The detection of the identifier by the identifier detection unit 34 may be performed by color analysis using general image processing or may be performed by using machine learning.

In step S8, the position information inquiry unit 36 of the imaging drone 12 inquires of the position information storage server 18 the position information of the position reference drone 16 including the identifier from the identifier detected in step S7.

In step S9 (an example of a position information acquisition step), the position information search unit 54 of the position information storage server 18 searches the position information storage unit 52 based on the information of the identifier inquired in step S8, and returns the position information of the corresponding position reference drone 16 to the imaging drone 12.

It should be noted that, in a case in which the position information of the position reference drone 16 and the image are associated with the time point information, the position information search unit 54 returns the position information of the position reference drone 16 having the time point information close to the time point information of the image to the imaging drone 12. As a result, the position information of the position reference drone 16 during capturing of the image can be appropriately acquired.

Finally, the position specification unit 38 of the imaging drone 12 specifies the positions of the latitude and the longitude of the ground surface in the image based on the position in the image of the identifier detected in step S7 and the position information returned in step S9 (an example of a specification step). The imaging drone 12 can specify the type of the feature in the image by performing registration between the image and the map data using the specified positions of the latitude and the longitude as the starting point.

Here, the imaging drone 12 can know the information on the latitude and the longitude of the position reference drone 16 detected in the image from the position information returned from the position information storage server 18. It should be noted that the acquired latitude and longitude are values on the ground surface, whereas the position reference drone 16 flies over the sky at certain altitude, so that the position of the position reference drone 16 in the image does not correspond to the acquired latitude and longitude as it is. The position in the image corresponding to the acquired latitude and longitude corresponds to the ground surface immediately below the position reference drone 16 in the image. The position of the ground surface immediately below the position reference drone 16 is calculated as follows.

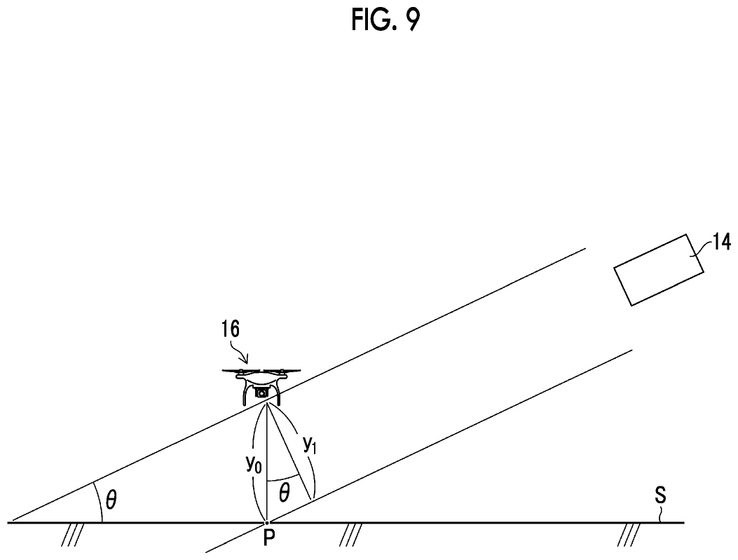

FIG. 9 is a diagram for describing a position P of the ground surface S immediately below the position reference drone 16. As shown in FIG. 9, in a case in which the position reference drone 16 at the altitude y₀ is imaged from the imaging unit 14 at the elevation angle θ, the altitude y₁ of the position reference drone 16 in the image is represented by Expression 1 below.

y₁=y₀×cosθ (Expression 1)

Here, the altitude y₀ is included in the position information acquired from the position information storage server 18. Moreover, the elevation angle θ (an example of elevation angle information) can be acquired from the gyro sensor provided in the imaging unit 14.

Therefore, the position P corresponding to the ground surface S immediately below the position reference drone 16 can be specified by obtaining the altitude y₁ from Expression 1, converting the altitude y₁ into a distance in an in-image coordinate system, and performing subtraction from in-image coordinates of the position reference drone 16.

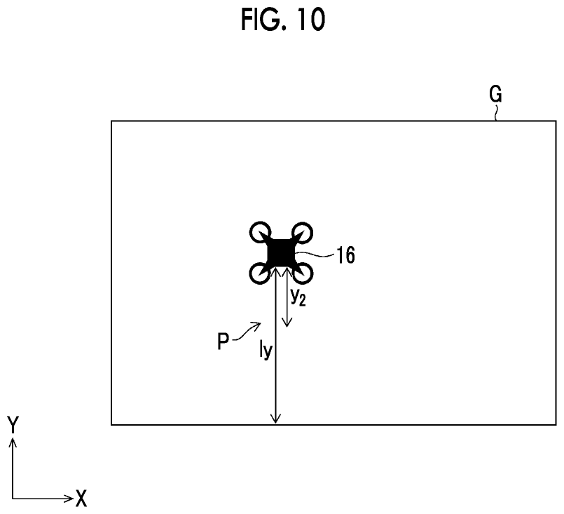

FIG. 10 is an example of an image G captured by the imaging unit 14. The position reference drone 16 is included in the image G. In this example, a position obtained by subtracting the distance y₂ in the in-image coordinate system of the altitude y₁ from ly, which is a y-coordinate of the position reference drone 16 in the image, is the position P corresponding to the ground surface S immediately below the position reference drone 16.

It should be noted that the image acquisition unit 32, the identifier detection unit 34, the position information inquiry unit 36, the position specification unit 38, the position information reception unit 50, the position information storage unit 52, and the position information search unit 54 of the position specification system 10 constitute the position specification device. The functions of the position specification device according to the present embodiment are distributed and provided in the imaging drone 12 and the position information storage server 18, but the position specification device may be provided in the imaging drone 12, may be provided in the position reference drone 16, or may be provided in the position information storage server 18.

For example, in a case in which the position specification device is provided in the position information storage server 18, the imaging drone 12 transmits the image captured by the imaging unit 14 to the position information storage server 18. The position information storage server 18 that has acquired the image can obtain the same effect as that of the present embodiment by performing the processing of step S7 to step S9. Moreover, since the processing in the imaging drone 12 can be reduced, the power consumption of the battery of the imaging drone 12 can be reduced.

### Second Embodiment

The identifier of the position reference drone 16 may be colored paper or paper on which the figure is drawn, as long as the identifier can be visually discriminated in the image.

Moreover, in a case in which the position to be imaged is fixed, paper on which a two-dimensional barcode in which the position information is encoded may be printed may be displayed. By using, as the identifier, the two-dimensional barcode in which the position information is encoded, the imaging drone 12 can acquire the position information of the position reference drone 16 directly from the captured image without going through the position information storage server 18.

Moreover, the plurality of position reference drones 16 may form the figure pattern. For example, the plurality of position reference drones 16 each comprising one LED light 30 can be arranged horizontally in a circular shape to form a circular figure pattern.

### Third Embodiment

In a case in which the position reference drone 16 cannot be detected from the image captured by the imaging drone 12, that is, in a case in which the position reference drone 16 is not present within the angle of view of the imaging unit 14, the imaging drone 12 instructs the position information storage server 18 to move the position reference drone 16 to a position within the imaging range of the imaging unit 14. For the position within the imaging range of the imaging unit 14, the latitude and the longitude of a 2 km point along a way of a traveling direction from the current position of the imaging drone 12 are calculated, and are notified to the position information storage server 18 as movement destination information.

The position information storage server 18 receives the movement destination information of the position reference drone 16 and decides the position reference drone 16 to be moved among the plurality of position reference drones 16. As the position reference drone 16 to be moved, the position reference drone 16 having a smallest number of times the position information is inquired within a certain period in the past is selected.

As described in the first embodiment, the imaging drone 12 detects the identifier of the position reference drone 16 included in the image, and inquires of the position information storage server 18 the position information of the position reference drone 16 including the identifier. Therefore, the fact that the number of inquiries about the position information is small means that the number of times of imaging by the imaging unit 14 is small.

The position information storage server 18 notifies the selected position reference drone 16 of the movement destination information received from the imaging drone 12. The position reference drone 16 that has received the movement destination information stops displaying the identifier and flies toward the positions of the latitude and the longitude of the movement destination. After arriving at the movement destination, the position reference drone 16 notifies the position information storage server 18 of the position information and the identifier information as in the first embodiment, and restarts displaying the identifier.

In this way, even in a case in which the position reference drone 16 cannot be detected from the image captured by the imaging drone 12, the position reference drone 16 can be moved within the imaging range.

### Others

The example has been described in which the imaging drone 12 is used as the imaging flying object, but a flying object, such as a radio control airplane or a radio control helicopter, may be used as the imaging flying object. Moreover, the imaging flying object is not limited to the unmanned flying object, and a manned airplane, a helicopter, or the like may be used.

The example has been described in which the position reference drone 16 is used as the position reference moving object, but a flying object, such as a radio control airplane or a radio control helicopter, may be used as the position reference moving object. Moreover, the position reference moving object is not limited to the flying object, and a traveling moving object, such as a robot or a radio control car, which can be operated wirelessly may be used.

The technical scope of the present invention is not limited to the range described in the embodiments described above. The configurations and the like in each embodiment can be appropriately combined between the respective embodiments without departing from the spirit of the present invention.

### EXPLANATION OF REFERENCES

10: position specification system
12: imaging drone
14: imaging unit
16: position reference drone
18: position information storage server
18A: processor
18B: memory
18C: communication interface
19: communication network
20: GPS receiver
22: atmospheric pressure sensor
24: azimuth sensor
26: gyro sensor
28: communication interface
30: LED light
30A to 30J: LED light
32: image acquisition unit
34: identifier detection unit
36: position information inquiry unit
38: position specification unit
40: identifier display unit
42: position information transmission unit
50: position information reception unit
52: position information storage unit
54: position information search unit
F: imaging range
G: image
Ly: coordinate
P: position
S: ground surface
Y₀: altitude
Y₁: altitude
Y₂: distance
θ: elevation angle
S1 to S9: each step of position specification method

What is claimed is:

1. A position specification device comprising:
a memory that stores a command to be executed by a processor; and
the processor that executes the command stored in the memory,
wherein the processor
acquires an image of a ground surface including a position reference moving object including a visual identifier, the image being captured by a camera provided in an imaging flying object that flies over the sky,
detects the identifier from the image,
acquires position information of the position reference moving object during capturing of the image, and
specifies a position of the ground surface in the image from the detected identifier and the position information.

2. The position specification device according to claim 1,
wherein the identifier includes a color defined for each position reference moving object.

3. The position specification device according to claim 1,
wherein the identifier includes a figure defined for each position reference moving object.

4. The position specification device according to claim 1,
wherein the identifier includes a two-dimensional barcode in which the position information is encoded.

5. The position specification device according to claim 1,
wherein the position reference moving object is a flying object that flies at an altitude lower than an altitude of the imaging flying object, and
the position information includes altitude information.

6. The position specification device according to claim 5,
wherein the processor
acquires elevation angle information of the camera during capturing of the image, and
specifies a position of the ground surface immediately below the position reference moving object in the image based on the altitude information and the elevation angle information.

7. The position specification device according to claim 1,
wherein the processor moves the position reference moving object to a position within an angle of view of the camera in a case in which the position reference moving object is not present within the angle of view of the camera.

8. The position specification device according to claim 7,
wherein the processor moves the position reference moving object, which has a smallest number of times the position information is acquired among a plurality of the position reference moving objects, to the position within the angle of view of the camera.

9. A position specification system comprising:
the position specification device according to claim 1;
the position reference moving object; and
the imaging flying object including the camera.

10. A position specification method comprising:
an image acquisition step of acquiring an image of a ground surface including a position reference moving object including a visual identifier, the image being captured by a camera provided in an imaging flying object that flies over the sky;
a detection step of detecting the identifier from the image;
a position information acquisition step of acquiring position information of the position reference moving object during capturing of the image; and
a specification step of specifying a position of the ground surface in the image from the detected identifier and the position information.

11. A non-transitory, computer-readable tangible recording medium on which a program for causing, when read by a computer, the computer to execute the position specification method according to claim 10 is recorded.
